(19) United States
(12) Patent Application Publication
(10) Pub. No.: US 2008/0263145 A1
(43) Pub. Date: Oct. 23, 2008

(54) SYSTEM AND METHODS FOR GENERATING PRO-FORMA BASED UPON INPUT PROVIDED VIA A COMMUNICATIONS NETWORK

(75) Inventor: Leslie Jebson, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., Gainesville, FL (US)

(21) Appl. No.: 12/106,793

(22) Filed: Apr. 21, 2008

Related U.S. Application Data
(60) Provisional application No. 60/913,061, filed on Apr. 20, 2007.

(51) Int. Cl. G06F 15/16; G06F 3/048

(52) U.S. Cl. 709/203; 715/808

(57) ABSTRACT

A system and related methods and procedures are provided for gauging the financial and operational implications of various types of investment decisions. Among the various applications of the invention, the invention can be used to conveniently and efficiently assess employment decisions, including, for example, the hiring of a new physician by a medical group or hospital and the hiring of an additional attorney to expand a legal practice, in any type of practice setting.

### CROSS-REFERENCE TO RELATED APPLICATIONS

This application claims the benefit of U.S. Provisional Patent Application No. 60/913,061, which was filed Apr. 20, 2007 and which is incorporated herein in its entirety.

### STATEMENT REGARDING FEDERALLY SPONSORED RESEARCH OR DEVELOPMENT

Not applicable.

### FIELD OF THE INVENTION

The present invention is related to the fields of data processing and communications networks, and more particularly, to utilizing such processing and networks to electronically generate various types of pro-forma.

### BACKGROUND OF THE INVENTION

The long-term viability of virtually all types of organizations, be they commercial ventures or not-for-profit entities, frequently depends on making critical investment decisions. Such decisions can include the decision to hire new employees, to expand existing facilities, and to purchase new equipment. For example, a critical investment decision for a group medical practice or law firm is deciding whether to expand the practice by hiring additional professionals. Similarly, critical investment decisions for a large not-for-profit medical research and teaching facility include, for example, deciding whether to hire new professors, to purchase the latest cutting-edge medical equipment, and to undertake new construction to expand the size or operations of the facility.

The same considerations pertain to individuals making personal decisions as well. For example, a professional, such as a physician or attorney, deciding whether to move to a new practice or establish one in a different region must make many of the same assessments to determine whether such a move is in the professional's best interest.

Making these kinds of decisions typically involves assessing a multitude of factors. For example, in the context of hiring a new physician for a group medical practice or large hospital, the decision can require consideration of prevailing physicians' salaries. This may require information about salaries at the regional level or even the national level, depending on the appropriate market for a particular medical specialty. Additionally, any expected increase in revenues to be generated by hiring a new physician must be estimated. Increased costs, such as the cost of additional medical malpractice coverage, must be weighted against the estimated increase in revenue if an optimal decision is to be made.

The assessments of risks, expected benefits, and anticipated costs, however, can be extremely difficult to make. Typically, making these assessments requires access to a vast amount of different types of data, data which is often difficult to obtain. Often times an even greater challenge can be to identify and locate a source from which the needed data can be obtained. Moreover, putting the data together to arrive at an accurate assessment of any of the various factors can be a daunting task. Thus, the number of man-hours of research and evaluation that goes into making these types of decisions can be considerable.

Accordingly, there is a need for a system and procedures for acquiring, processing, and presenting the myriad information needed to make accurate investment decisions. In particular, there is a need for a system and procedures for accurately and efficiently generating pro-forma, particularly financial pro-forma, which can serve as the basis for making investment decisions like those regarding hiring new personnel, purchasing new equipment, and expanding existing facilities or operations.

### SUMMARY OF THE INVENTION

The invention is directed to a system and related methods and procedures that provide a unique and efficient infrastructure for gauging the financial and operational implications of various types of investment decisions. Among the various applications of the invention, the invention can be used to conveniently and efficiently assess employment decisions, including, for example, the hiring of a new physician by a medical group or hospital or the hiring of an additional attorney to expand an existing legal practice, in any type of practice setting.

According to one embodiment of the invention, the system can be implemented as an Internet website. For example, in the context of physician hiring—whether it is an existing family practice physician looking to relocate to another state, or a hospital administrator considering the employment of a cardiologist for a new heart program—the website can provide a ‘decision-string’ procedure that allows for the rapid, unbiased, and concise generation of an Adobe PDF or other type of printer-friendly pro-forma, typically in only a matter of minutes.

With the migration of Internet revenue shifting towards impression-based advertising models, the website can be designed to maintain a captive audience through multiple screen presentations utilizing question-based logic. As a result of this migration, the website can be implemented as an advertising-based revenue model. The website also can establish a reciprocal link service through collaboration with various entities, such as payscale.com, salary.com and monster.com.

The website, moreover, can be implemented with the most current hypertext markup language (HTML) and international web design standards so as to ensure minimal distortion, and to maintain a consistent appearance and presentation over the Internet. The website can also be equipped with an advertising content manager that can be maintained by clerical, secretary-level professional. The system additionally can include a reporting module or system for state-specific usership measurements through tracking during any predetermined timeframe, ranging from daily to annual tracking.

Users can choose to enter specific free-text values. Alternatively, users can opt to have the hidden decision logic system make recommendations for them based on the accessible databases or data sets containing publicly-available information, such as health data, relocation services, and malpractice rates.

The website can be hosted on any type of server, including a basic server. Manual upgrades need be made only annually. Although, the system is illustratively described herein primarily in terms of physician practices, the infrastructure of the invention is scalable and can easily be established for other professional services, including for dental practices and the market for physician assistants, for example.

### BRIEF DESCRIPTION OF THE DRAWINGS

There are shown in the drawings, embodiments which are presently preferred. It is expressly noted, however, that the invention is not limited to the precise arrangements and instrumentalities shown.

FIGS. 1A and 1B are schematic diagrams exemplary network environments in which is deployed a system for electronically generating financial and other pro-forma, according to one embodiment of the invention.

FIG. 2 is a schematic diagram of a system for electronically generating financial and other pro-forma, according to another embodiment of the invention.

FIG. 3 is a flowchart of exemplary steps in a method for electronically generating financial and other pro-forma, according to still another embodiment of the invention.

### DETAILED DESCRIPTION

The invention is directed to systems and methods for generating various types of pro-forma, including financial pro-forma that can serve as the basis for different types of investment decisions. These investment decisions include, for example, an organization's decision to hire new personnel, to purchase new equipment, and/or to expand an existing facility or operation. The invention can also permit individuals, such as physicians, dentists, and attorneys, to make more informed career decisions. As explained herein, the invention provides an electronic mechanism whereby user-supplied information and/or stored data is used to electronically generate pro-forma, such as financial pro-forma, for making such decisions.

The invention, more particularly, provides a platform that permits users to create a fusion between user-supplied information and information obtained from existing databases and data sets in order to create a basic estimate or a detailed, customized multi-year forecast regarding a particular decision. One of the advantages offered by the invention is that an endeavor that would otherwise typically entail hours of research, data assemblage, and evaluation can often be accomplished in only minutes.

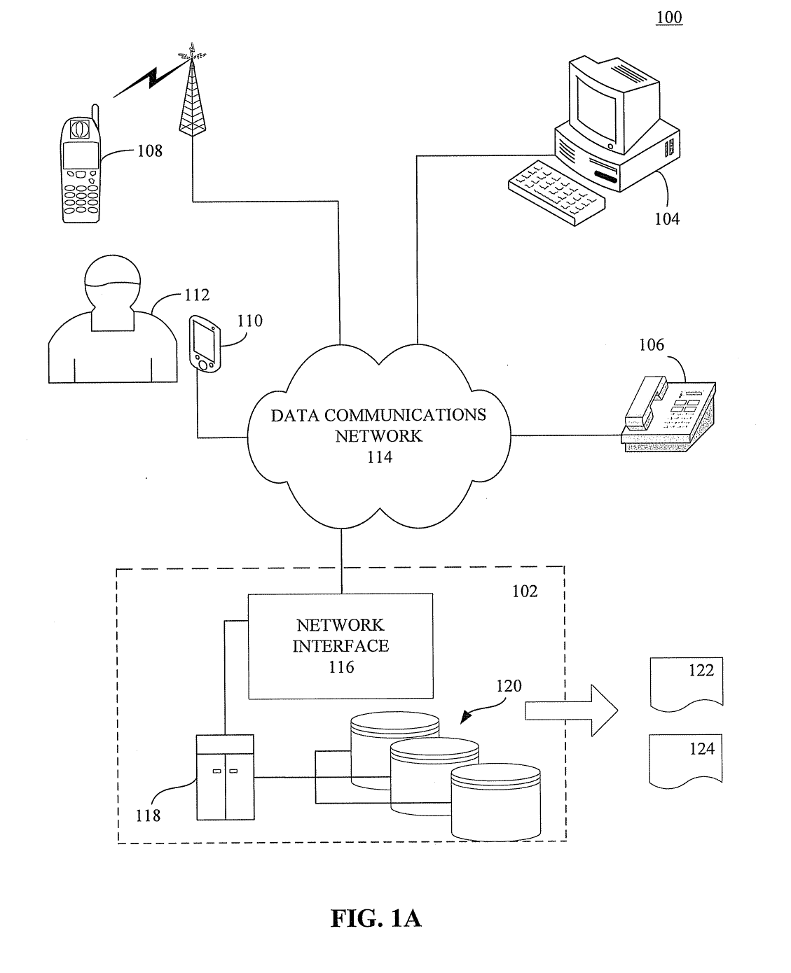

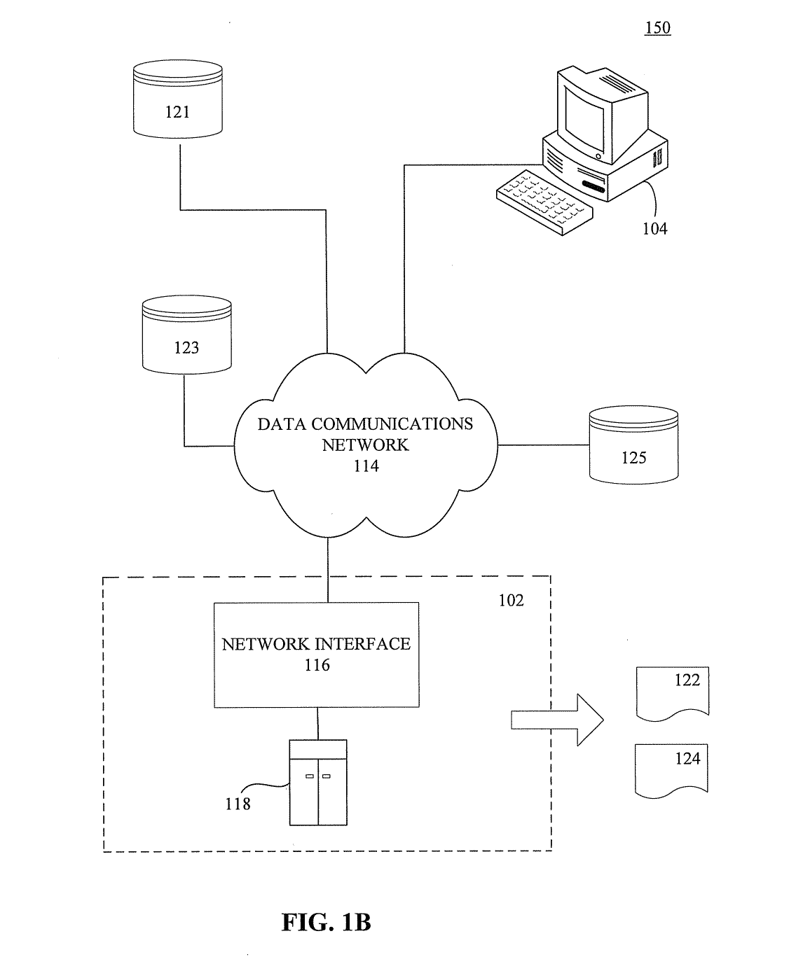

FIG. 1 is a schematic view of an exemplary network environment 100 in which an electronic data processing system 102, according to one embodiment of the invention, can be utilized. The system 102 can receive user-supplied information through the network, electronically process the information, and generate a user-requested proforma. The network environment 100 illustratively includes, in addition to the system 102, at least one computing device 104, at least one telephone device 106, at least one mobile communications device 108, and at least one handheld device 110, any one of which can be employed by the user to communicate with the system. Although only one of each type of device is shown for purpose of illustration, it will be readily apparent to one of ordinary skill in the art that a far greater number of each of these various types of devices can be used according to the invention.

The computing device 104 is illustratively a desktop computer. In other embodiments, however, the computing device 104 can be, additionally or alternatively, a laptop computer or similar type of device with which a user can input information using a computer keyboard or a computer mouse configured to effect point-and-click operations, for example. Indeed, when the computing device is combined with automatic speech recognition capabilities, the computing device 104 also can be a vehicle for inputting voice-based information.

The mobile communications device 108 is illustratively a cellular phone that communicates via a cellular network that includes at least one cellular tower 109 for receiving and conveying wireless signals. The cellular network can be communicatively linked to the system 102 directly and/or via a computer communications network. Additionally or alternatively, the mobile communications device 108 can communicate, for example, via a communications satellite or over a mobile communication network. The handheld device 110 can be, for example, a personal digital assistant (PDA), electronic tablet, or similar such device. Thus, the handheld device 110 can incorporate handwriting-recognition and/or speech-recognition features, allowing a user 112 to input information to the system 102 in written and/or spoken form.

Each of the various devices shown in the exemplary network environment 100 is illustratively linked to the system 102 via a computer communications network 114, such as the Internet, a wide area network (WAN), a local area network (LAN), or other such communication network configured to convey packetized data between the system 102 and the various network-connected devices 104-110, according to one or more known routing protocols. Thus, for example, voice signals can be conveyed between the telephone device 106 and the system 102 as Internet Protocol (IP) voice packets according to the International Telecommunications Union Telecommunication Standardization Sector (ITU-T) specification H.323 (VoIP).

Although illustratively shown as being connected to the system 102 via the computer communications network 112, in alternate embodiments one or more of the different devices connects directly to the system 102. Accordingly, the telephone 106 can communicatively link to the system 102 via a public switched telephone network (PSTN), for example.

The various network-connected devices provide entry points at which various users—for example, an entity such as a medical group, research and teaching hospital, law firm, or single individual—can submit information to the system 102 for processing according to the various procedures implemented by the system. When received by the system 102, the different forms of information are processed in order to create storable electronic data and to provide data that is a basis for the different types of pro-forma that can be generated by the system 102.

As illustrated, the system 102 includes a network interface 116 through which information is received directly and/or via the computer communications network 106. The system 102 further illustratively includes at least one processor 118 communicatively linked to the network interface 116 for processing received information. Additionally, the system 102 illustratively includes a plurality of databases 120 communicatively linked to the processor 118 to store electronic data.

The databases 120, more particularly, store various data sets that can be routinely updated to reflect factors such as changing national and regional market trends. These market trends, for example, can pertain to regional or national salary trends for professionals, such as physicians, dentists, and attorneys, as well as salary trends for other occupations and professions. Other market trends reflected in the data sets can be cost trends, such as the changing costs for malpractice insurance and the costs of generally-used or special-purpose equipment. As explained more particularly below, these data sets alone, or in conjunction with user-specific information, are analyzed by the system 102 to generate different types of user-requested pro-form a 122, 124.

Each generated pro-forma 122, 124 can be saved to the system 102 as a printable document, which also can include a reference dictionary of the supporting recommendation rationales of the analysis. Moreover, the particular pro-forma 122, 124 generated from the analysis performed by the system 102 can be rendered in a “ready-to-go” format so that the pro-form a can be easily included in any business proposal or write-up. Accordingly, the system 102 can enable a user to create an accurate forecast of the financial implications of virtually any type of investment decision, including, for example, salary, malpractice, recruitment and continuing medical education recommendations specific to a physician type for making an informed judgment about hiring a new physician by a group medical practice or hospital.

FIG. 1B is a schematic view of an alternative network arrangement 150 in which the electronic data processing system 102, according to another embodiment of the invention, can be utilized. According to this embodiment, the system 102 communicates through the data communications network 114 with one or more network-connected databases 121, 123, 125 that are remotely located from the system. Operatively, the system 102 executes a search procedure to locate among the plurality of remotely-located, network-connected databases 121, 123, 125 at least one database containing at least a portion of the information needed to generate a particular user-requested pro-forma.

For example, a group medical practice may be considering hiring an additional physician trained in a particular medical specialty. The group medical practice may not know the prevailing physician salaries for the particular medical specialty in the relevant geographic region. Accordingly, the system 102 executes the search procedure to identify one or more databases 121, 123, 125 from which the needed information can be obtained. Once the system 102 has identified at least one such database, the system can obtain the needed information for completing the analysis needed to generate the requested pro-forma.

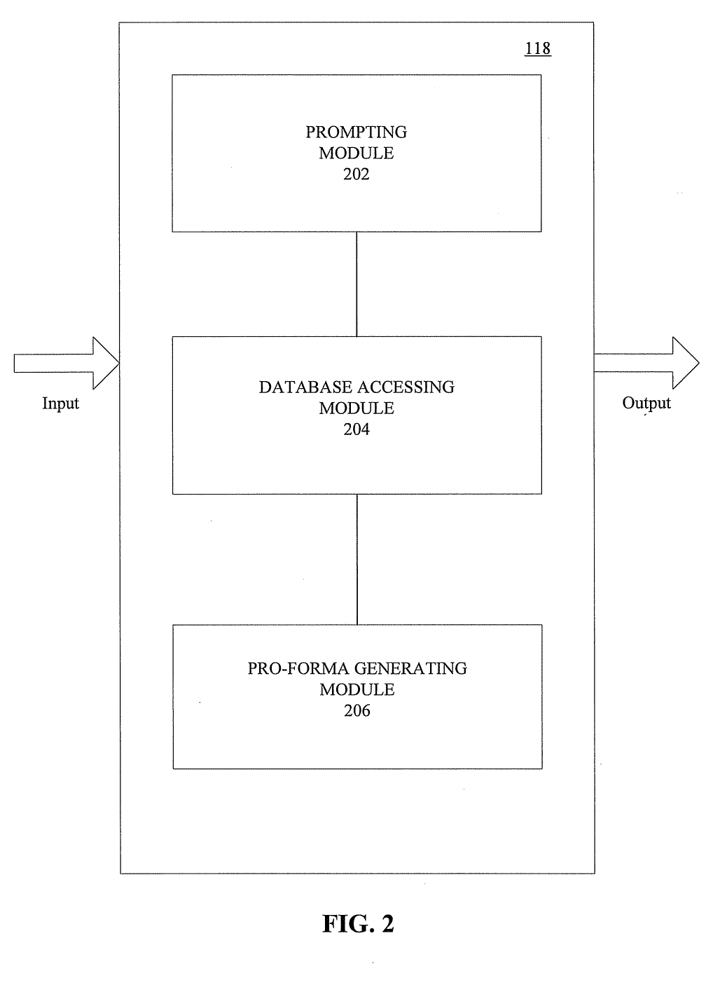

Illustratively, the electronic data processing system 102 can be implemented as a network connected server having at least one processor 118. FIG. 2 is a schematic view of the processor 118, according to one embodiment of the invention. The processor 118 illustratively includes a prompting module 202, a database accessing module 204, and a pro-forma generating module 206. Each of the prompting module 202, database accessing module 204, and pro-forma generating module 206 functions cooperatively with the other modules and with the other elements of the system 102. One or more of the modules 202, 204, 206, according to one embodiment, comprises computer-readable code configured to execute on a general-purpose or application-specific computer. In an alternative embodiment, one or more of the modules 2202, 204, 206 comprises dedicated hardwired circuitry. In still another embodiment, one or more of the modules 202, 204, 206 comprises a combination of computer-readable code and dedicated hardwired circuitry for carrying out the procedures effected by the system 102.

Operatively, the prompting module 202, incorporated in or executing on the server, presents to a user a series of prompts. Each of the series of prompts requests that the user supply a predetermined set of information needed for completing the analysis necessary for generating a particular, user-requested pro-forma.

One aspect of the invention is that the user is afforded an opportunity to rely on the system 102 to supply at least a portion of the predetermined set of information. Accordingly, if the user elects to use system-supplied data for constructing all or a portion of the predetermined set of information, the database accessing module 204 incorporated in or executing on the server automatically accesses at least one database and obtains the needed data. As noted above, the system 102, according to one embodiment, includes databases 120 that include regularly- or intermittently-updated datasets. According to an alternative embodiment, also noted above, the system 102 through the database accessing module 204 executes a search routine so as to identify one or more databases 121, 123, 125 having the needed data. According to this embodiment, the system 102 through the database accessing module 204 obtains the needed data from the identified database or databases 121, 123, 125 through the data communications network 114.

Either or both procedures can be employed to obtain needed data when a user elects to have the system 102 provide at least a portion of the predetermined set of information. Once the complete set of information has been assembled, the pro-forma generating module 206 incorporated in, or executing on, the server analyses the information in order to generate the particular, user-requested pro-forma.

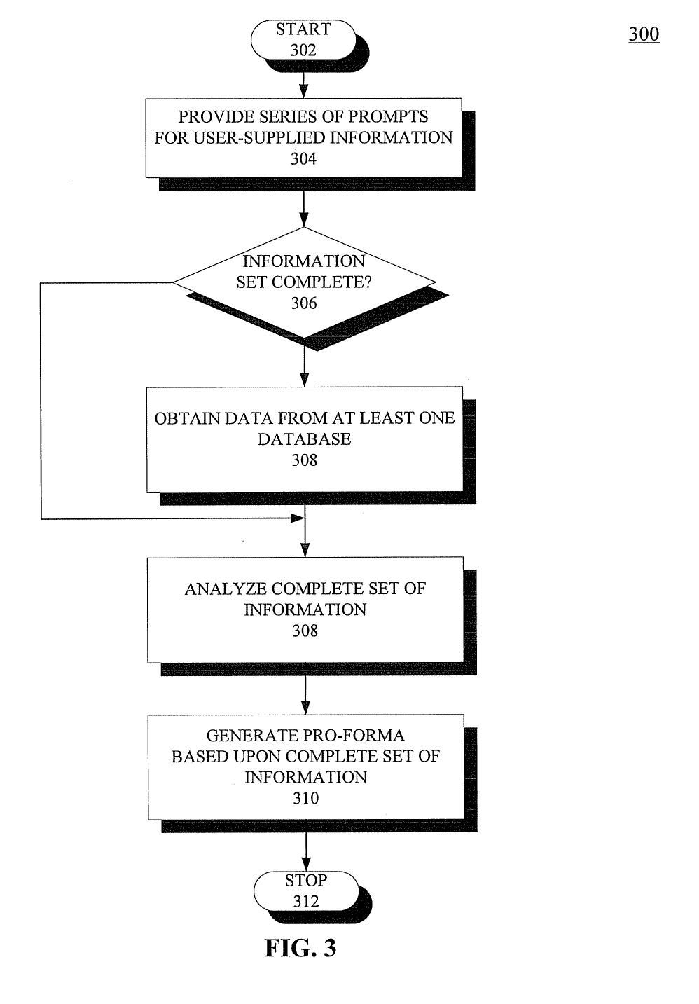

FIG. 3 is flowchart of exemplary steps illustrating an electronic data processing method 300 for generating a pro-forma. Illustratively, following that start at step 302, a series of prompts is provided to a user at step 304. Through the series of prompts, provided as a series of graphical displays and/or audible instructions, the user is directed to supply specific information to be analyzed and evaluated for generating a user-requested pro-forma.

At step 306, a determination is made as to whether the user-supplied information is sufficient to complete a predetermined set of necessary information, which is needed to generate the user-requested pro-forma. If the set of information is incomplete, the procedure proceeds to step 308, at which point one or more databases is identified as having the information needed and the needed information is obtained. The user may, either for the entire set of information or selected portions of information, explicitly elect that the information be obtained from one or more databases rather than be supplied directly by the user. According to one embodiment, the system-supplied information is obtained from predetermined databases. According to still another embodiment, the information is obtained by searching multiple, publicly-accessible databases accessed through a data communications network in order to identify and retrieve the information.

Once the predetermined set of information is complete, the procedure continues at step 308 with an analysis of the complete set of information. Based on the analysis and evaluation of the information, a user-requested pro-forma is generated at step 310. Illustratively, the method concludes at step 312.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, such as magnetized tape, an optically-readable disk, or other computer-readable medium, in which is embedded computer-readable code defining a computer program for causing a computer or computer-based system to implement the methods described herein when loaded in the computer or computer-based system. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. An electronic data processing method for generating a pro-forma, the method comprising:
providing a network-connected server, wherein the server is accessed by a user through a data communications network when the user is remotely located from the server, and wherein the server is configured to present to the user a series of prompts prompting the user to supply a predetermined set of information;
automatically accessing at least one database if in response to one or more of the prompts the user elects to have at least a portion of the predetermined set of information be supplied from the at least one database; and
generating a user-requested pro-forma based upon the predetermined set of information.

2. The method of claim 1, wherein the user accesses the network-connected server through at least one of a local area network (LAN), a wireless LAN (WLAN), and the Internet.

3. The method of claim 1, wherein the user is prompted to supply the predetermined set of information by presenting to the user at least one graphical image on a remotely-located device display.

4. The method of claim 1, wherein the step of automatically accessing at least one database further comprises performing an electronic search of a plurality of network-connected databases remotely-located from the server to identify at least one database that can supply at least a portion of the predetermined set of information.

5. The method of claim 1, wherein at least a portion of the predetermined set of information includes at least one numerical estimation, the method further comprising supplying at least a portion of the predetermined set of information by obtaining data from the at least one database and automatically generating the at least one numerical estimation.

6. The method of claim 1, wherein the user supplies at least a portion of the predetermined set of information as a spoken utterance or electronic data using a mobile communications device wirelessly linked to the data communications network through an access point.

7. The method of claim 1, further comprising converting at least a portion of the generated proforma into a speech output using a text-to-speech engine and conveying the speech output to the user.

8. An electronic data processing system for generating a pro-forma, the system comprising:
a network-connected server that is accessed by a user through a data communications network when the user is remotely located from the server;
an electronic processor residing on the network-connected server;
a prompting module incorporated in or executing on the server to present to the user a series of prompts prompting the user to supply a predetermined set of information;
a database accessing module incorporated in or executing on the server to automatically access at least one database if in response to one or more of the prompts the user elects to have at least a portion of the predetermined set of information be supplied from the at least one database; and
a pro-forma generating module incorporated in or executing on the server to generate a user-requested pro-forma based upon the predetermined set of information.

9. The system of claim 8, wherein the network-connected server is accessible through at least one of a local area network (LAN), a wireless LAN (WLAN), and the Internet.

10. The system of claim 8, wherein the prompting module is configured to prompt the user to supply the set of predetermined by presenting to the user at least one graphical image on a remotely-located device display.

11. The system of claim 8, wherein the database accessing module is configured to perform an electronic search of a plurality of network-connected databases remotely-located from the server to identify at least one database that can supply at least a portion of the predetermined set of information.

12. The system of claim 8, wherein at least a portion of the predetermined set of information includes at least one numerical estimation, the method further comprising supplying at least a portion of the predetermined set of information by obtaining data from the at least one database and automatically generating the at least one numerical estimation.

13. The system of claim 8, further comprising a speech-recognition engine, wherein the speech-recognition engine is configured to convert voice utterances received via a network interface.

14. The system of claim 13, wherein the speech-recognition engine is configured to convert voice utterances received from a telephony device connected to the system through a circuit-switched telephony network or a packet-switched network.

15. The system of claim 13, wherein the speech recognition engine is configured to convert voice utterances received from a wireless communications device via a connection between the system and a wireless cellular or mobile network.

16. The system of claim 8, further comprising an electronic tablet communicatively linked to the processor to convert written data entered into the electronic tablet into an electronic data format.

17. The system of claim 8, further comprising a text-to-speech engine for converting the generated pro-forma into a speech output that is conveyed to the user.

18. A computer-readable storage medium having embedded therein computer code for generating a pro-forma, the computer code comprising instructions for:
presenting to a user a series of prompts prompting the user to supply a predetermined set of information;
automatically accessing at least one database if in response to one or more of the prompts the user elects to have at least a portion of the predetermined set of information be supplied from the at least one database; and
generating a user-requested pro-forma based upon the predetermined set of information.

19. The computer-readable storage medium of claim 18, wherein the computer code instruction for automatically accessing at least one database further comprises computer code for performing an electronic search of a plurality of network-connected databases remotely-located from the server to identify at least one database that can supply at least a portion of the predetermined set of information.

20. The computer-readable storage medium of claim 18, wherein at least a portion of the predetermined set of information includes at least one numerical estimation, and wherein the computer code further comprises an instruction supplying at least a portion of the predetermined set of information by obtaining data from the at least one database and automatically generating the at least one numerical estimation.
